(19) United States
(12) Patent Application Publication
(10) Pub. No.: US 2002/0135771 A1
(43) Pub. Date: Sep. 26, 2002

(54) System and method of reducing particulate interference in fluid analyte detection

(75) Inventor: Thomas R. Witty, Santa Cruz, CA (US)

Correspondence Address: MERCHANT & GOULD PC, P.O. BOX 2903, MINNEAPOLIS, MN, 55402-0903, US

(73) Assignee: Quantech Ltd

(21) Appl. No.: 09/765,834

(22) Filed: Jan. 19, 2001

(51) Int. Cl. G01N 21/55

(52) U.S. Cl. 356/445; 356/39

(57) ABSTRACT

A system and method for limiting particulate interference at a test element surface in a flow cell. The system includes a fluid conduit for allowing the particulate component of the sample to settle with gravity and a flow cell for analyzing the reduced particulate zone formed in the fluid conduit.

### FIELD OF THE INVENTION

The invention relates to methods and systems for analyte detection in a sample having a particulate component. More Specifically, the invention is directed to methods and systems for reducing particulate interference during analyte detection of a sample.

### BACKGROUND OF THE INVENTION

A variety of devices and methods have been developed to detect and quantify the changes in reflective index by the binding of an analyte to the surface of a test element. Such devices have been used in the detection of analytes in the clinical, environmental, agricultural and biotechnological disciplines. Examples of such methods include ellipsometry, external Brewster angle reflectometry, UV-Vis spectroscopy, infrared spectroscopy, NMR spectroscopy, ESR spectroscopy, evanescent wave reflectometry, Brewster angle reflectometry, critical-angle reflectometry, evanescent wave ellipsometry, surface plasmon resonance, scattered total internal reflection, optical waveguide sensing methods, refractometric optical fiber sensing methods, leaky waveguide sensing methods, resonance light scattering of particles, multilayered grating resonance, and diffraction anomaly grating methods. Surface plasmon resonance provides one example of these techniques that can be used to indicate the presence, amount, or concentration of an analyte in a sample based on a change in refractive index. In particular, as described, for example, in U.S. Pat. Nos. 4,931,384; 4,828,387; 4,882,288; 4,992,385; 5,118,608; 5,164,589; 5,310,686; 5,313,264; 5,341,215; 5,492,840; 5,641,640; 5,716,854; 5,753,518; 5,898,503; 5,912,456; 5,926,284; 5,944,150; 5,965,456; 5,972,612; and 5,986,762, PCT Patent Applications Publication Nos. WO 88/07202 and WO 88/10418, and UK Patent Application Publication No. GB 2 202 045, all of which are incorporated herein by reference, the shift of a notch in a surface plasmon resonance spectrum can be correlated to the presence, amount, or concentration of an analyte in a sample. Other techniques listed above measure a change in a different property. Such changes can include, for example, a change in the numerical value of a measured property (e.g., an increase or decrease in intensity of reflected/transmitted/absorbed light, a change in polarization angle, or an increase or decrease in polarization) or a shift in frequency of a resonance or other spectral condition.

A number of these methods respond to a change in the refractive index on the surface of a test element. Typically, the analyte in a sample binds to the surface of the testing element, resulting in a refractive index change. The refractive index change is indicative of the presence and amount of analyte in any particular solution.

Interference with analyte binding at the test element surface is detrimental to obtaining consistent and reliable results. Interference can be from particulate matter in the sample, where particles in the sample physically interfere with analyte binding sites on the testing element. Interference from particulate matter in the sample may also hinder the diffusion of the analyte to the testing element. For example, the detection of analytes within a sample of blood can be hindered by the cellular component of the blood, where cells within the blood block analyte binding sites on the surface of the test element, and hinder or interfere with the diffusion of analytes to the potential binding sites on the test element.

A number of strategies have been developed to overcome particulate interference at a test element surface, including the use of a pre-analytical step(s) on the sample to remove the particulate fraction from the sample, allowing for analyte detection to be performed on a particulate free sample, e.g., a cell free plasma sample in the case of blood. However, the pre-analytical treatment of a sample takes time, requires specialized equipment, and is a source of potential sampling error. It is thus advantageous to determine or analyze target analytes directly in a starting sample, without having to perform pre-analytical steps.

Another strategy for dealing with particulate interference at the testing element is to incorporate separation techniques (e.g., centrifugation/filtration) into the analysis of the starting sample. Here, the device and method incorporate steps to remove the particles from the starting sample before testing for the target analyte. These devices improve the simplicity of the test and reduce pre-analysis type errors, but require significantly more complex and costly instrumentation that can accomplish both the separation and analysis portions, of the procedure.

A third approach to avoiding particulate interference in analyte detection at a testing element surface is to limit the depth of penetration of the analytical detector in the sample to an area less than an average particle diameter. However, this technique requires the analyte to migrate to the analytical surface through the particles in the bulk solution, again inducing an error in the consistency and reproducibility of the results, and, because particles often vary in size, the particles typically occupy some amount of space within the analytical vector's depth of penetration.

Against this backdrop the present invention has been developed.

### SUMMARY OF THE INVENTION

In accordance with the present invention the above problems and others have been solved by a system and method for reducing particulate density interference in a fluid sample at an analyte testing site.

One embodiment of the invention is a system for determining the presence of an analyte in a particulate containing fluid sample. In one embodiment, the system includes a flow cell having an internal chamber for passing the fluid sample therethrough, where the internal chamber has a window and a test element. The system also includes a fluid conduit for bringing the fluid sample to the flow cell and, in some embodiments, providing a region for the settling of the particulate component of the sample in the direction of gravity, thus forming an analytical zone. The analytical zone having a reduced density of particulate as compared to the remainder of the sample, or non-analytical zone. In general, the settling distance of the particles in the sample is small, and the test element is affected only by close proximity of materials within approximately 100 nm of the surface.

Another embodiment of the present invention is a method of determining a presence of an analyte in a particulate containing fluid sample. The method includes the steps of providing a fluid sample having a particulate component to a fluid conduit where the particulate component of the sample settles with gravity and where an analytical zone is formed in the sample having a reduced density of particles as compared to the remainder of the sample, or non-analytical zone. Additionally, the method includes the steps of passing the analytical zone over a test element surface to bind an analyte and to analyze the test element surface for the presence of the analyte.

These and various other features as well as advantages which characterize the present invention will be apparent from a reading of the following detailed description and a review of the associated drawings.

### BRIEF DESCRIPTION OF THE DRAWINGS

The invention may be more completely understood in consideration of the following detailed description of various embodiments of the invention in connection with the accompanying drawings, in which:

FIG. 1 illustrates the forces of gravity, buoyancy and viscosity felt by an object in a fluid sample;

FIG. 2 is a schematic illustration of one embodiment of an analyte detection device, according to the invention;

FIG. 3A is a schematic illustration of a second embodiment of an analyte detection device, according to the invention;

FIG. 3B is a schematic illustration of a third embodiment of an analyte detection device, according to the invention;

FIG. 4 is a schematic illustration of an expanded view of a test element consistent with embodiments of the invention;

FIG. 5 is a schematic illustration of a second embodiment of a test element consistent with the invention.

FIG. 6A is a schematic cross-sectional view of a test element with first analyte-binding partner disposed thereon, according to the invention;

FIG. 6B is a schematic cross-sectional view of the test element of FIG. 6A with analyte coupled to the first analyte-binding partner, according to the invention;

FIG. 6C is a schematic cross-sectional view of the test element of FIG. 6B with second analyte-binding partner coupled to the analyte, according to the invention;

FIG. 7 is a flow diagram showing a method for detecting an analyte in a sample having a cellular component;

FIG. 8 is a bar graph depiction of cellular interference at the top surface of a flow cell and at the bottom surface of the flow cell; and

FIG. 9 is a graph illustrating myoglobin quantification in a whole blood sample and in a cell-free plasma sample, according to the invention.

### DETAILED DESCRIPTION OF THE PREFERRED EMBODIMENT

Embodiments of the present invention reduce interference of particulates in a fluid sample with analyte determination at a test element surface. One particular application for the present invention is in analyte detection and quantification in a bodily fluid, for example the quantification of glucose in whole blood.

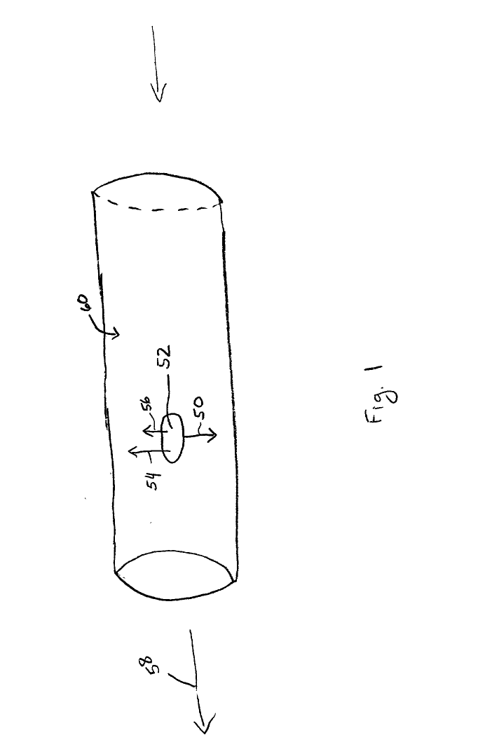

The present invention takes advantage of the sedimentation properties of a particle, for example a cell, in a moving fluid where the force of gravity on the particle is counteracted by the particle's buoyancy and to a lesser extent, the liquids viscosity. Referring to FIG. 1, gravity, as shown by arrow 50, exerts a downward force on the particle 52, which is counteracted by the upward forces of buoyancy and viscosity, shown by arrows 54 and 56 respectively. The overall effect on the sample is that a reduced density of cells or particles is created along the upper layer of the moving fluid, shown by arrow 58. This reduced density zone is referred to as the analytical zone 60, and is the portion of the flowing sample targeted for analyte testing at the testing element (see below).

The depth of the analytical zone 60, i.e., the depth of the fluid having reduced levels of particles, is dependent on the make-up of the sample, i.e., viscosity of the solution, and size and weight of the particles in solution, the force of gravity, and any modifications thereof, and on the amount of time the analytical zone is allowed to “form” or equilibrate before the sample is tested. In general, the analytical zone is as deep as forces on the sample allow, the zone can be at least 10 to 500 nanometers (nms) in depth, is typically 50 to 350 nms, and is preferably 100 to 200 nms in depth.

Additionally, because the sample is in motion through the testing device, the velocity of the fluid provides for the accurate renewal and diffusion of analyte to the analyte testing site.

In the context of the present invention, the analytical zone is the sampling portion of the inputted fluid. Because the analytical zone of a sample has reduced particulate interference and presents a constantly renewing source of analyte for testing, it provides an optimum context for determining the presence and concentration of a target analyte.

Definitions

When used herein, the following definitions define the stated term:

The term “analyte” is used to mean any specific component being analyzed in a sample. Example analytes include, but are not limited to, proteins, e.g., cardiac marker, insulin, nucleic acid, e.g. RNA, DNA, drugs, e.g., digoxin, salicytates, toxins, small molecules, e.g., glucose, bilirubin, ethanol, etc.

The term “analytical zone” means the layer of particle reduced, e.g., cell reduced, sample that is appropriate for analyte testing at the test element surface. The analytical zone has a reduced density of particles as compared to the non-analytical zone.

The term “reduced density” means to have fewer particulates per unit volume in the sample as compared to the number of particulates per unit volume of the sample's starting material.

The term “testing element” means a surface at which target analytes are analyzed.

Testing Devices

Embodiments of the present invention limit the interference of the particulate component of a fluid with the analyte detecting surface of a testing element. In general, fluid samples are passed through the detection apparatus such that the heavier components of the sample settle and provide an analytical zone having a reduced density of particulates as compared to the remainder of the sample or non-analytical zone. At the same time, movement of the fluid through the detection apparatus replenishes the analyte component of the analytical zone so that an accurate analysis can be made on the sample.

For exemplary purpose the invention will be discussed with reference to cells in whole blood, but it will be appreciated that the discussion is applicable to any situation where a particulate in a fluid interferes with the testing of target analytes in the sample. Other examples where a fluid might be contaminated with a particulate include, but are not limited to, bodily fluids contaminated with blood, interstitial fluid, synovial fluid, lymph, urine, saliva, environmental samples, etc.

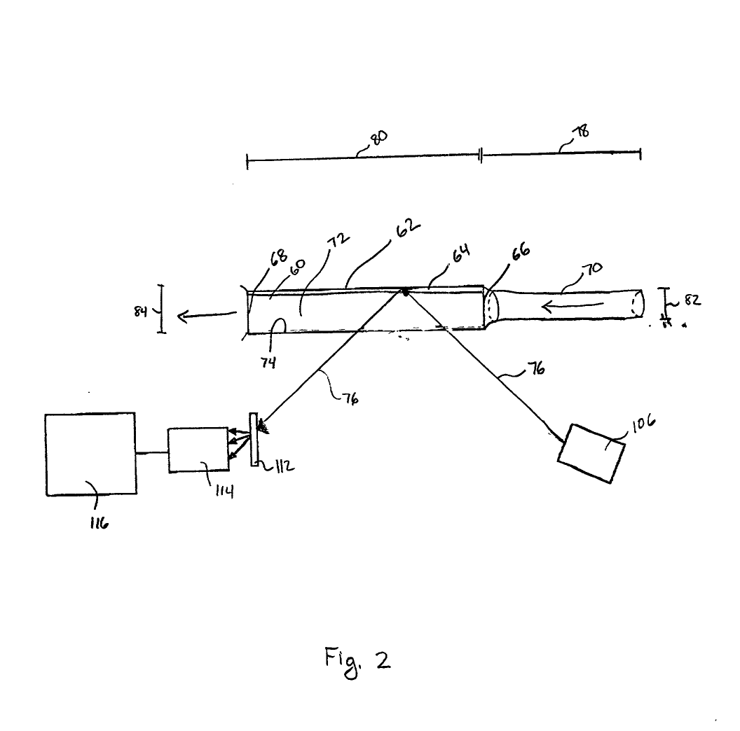

One embodiment of the present invention is a device having a flow cell 62 that provides a pathway for a fluid sample to flow therethrough and that supports a test element 64 for the detection of an analyte in the fluid sample, as is shown in FIG. 2. In the illustrated embodiment, the flow cell 62 is a tube-like structure having two open ends, a first end 66 for receiving the fluid sample and a second end 68 for exit of the fluid sample. A fluid conduit 70 of similar bore as the flow cell 62 is attached to the first end 66 of the flow cell 62 for delivery of the fluid to the flow cell. The conduit 70 can be from 2 to 500 millimeters (mm) in length, typically from 100 to 300 mm in length, and preferably about 145 to 155 mm in length. Further, the conduit has a diameter of 0.05 to 1 mm, and preferably from 0.075 to 0.1 mm. In another embodiment of the invention, the conduit defines a square shaped cross section, having relatively flat surfaces, i.e., top, bottom, and sides. In this embodiment, the conduit has a similar size and shape as the flow cell. Note that other conduit shapes may be used in the context of the present invention as long as the conduit shapes do not cause an undue level of fluid turbulence in the sample. An undue level of turbulence is such that particulates within the sample that should settle are completely unable to settle, and thus an analytical zone is not formed.

In one embodiment, the fluid conduit 70 is straight and on the same plane as the flow cell 62 having no changes in direction before reaching the first end 66 of the flow cell 62. The fluid conduit 70 provides an equilibrating or sedimenting region where the particulate or cellular components of the sample are acted upon by uniform forces of gravity, buoyancy and viscosity, thus allowing the particulate or cellular components of the sample to settle within the flowing fluid. As such, in a typical sample, an analytical zone 60 forms at the upper layer of the fluid having a reduced density of particles, and as such undergoes limited particulate interference upon analyte detection.

In one embodiment, the flow cell 62 has an open ended internal chamber 72. The internal chamber 72 provides surfaces for directing the flowing sample through the flow cell 62 and for supporting the analyte detecting element, i.e., the testing element 64, of the present invention. Generally, the surfaces of the internal chamber 72 are smooth. Typical flow cell 62 lengths can be about 200 mm to 10 cm, typical lengths are about 1 cm to 4 cm, and preferably lengths are about 2 to 4 cm.

The internal chamber 72 of the flow cell 62 can be shaped as an open-ended elongated rectangular box, having a relatively flat top and bottom surfaces. The connecting side surfaces of the chamber are also typically flat, although any shape can be used as long as non-turbulent flow is maintained as the sample is passed through the flow cell and the analytical zone 60 is maintained along the testing element.

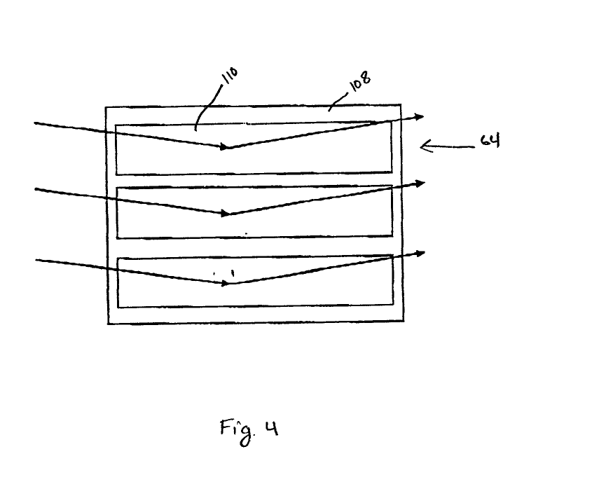

In one embodiment the analyte binding test element 64 is located along a portion of the top surface, adjacent the sample analytical zone 60, of the internal chamber 72 (see also FIG. 4). Opposite the testing element 64, typically on the bottom surface of the internal chamber, is a clear window 74 for the passage of light, shown by arrow 76, into and out of the flow cell 62. The window 74 provides for the passage of directed light into and out of the flow cell 62 as is required for analyte detection on the test element surface (see below). The window is preferably made of selected optical grade glass, for example borosilicate glass, and plastics, eg acrylic, etc. Typical flow cell windows 74 transmit 80% of light from 600 through 900 nm, and preferably transmit 90% of light from 700 through 800 nm.

Embodiments of the present invention have sample flow rates optimized for maximum binding efficiency at the test element 64. The flow rates of the sample are dependent on the forces of gravity and buoyancy, the sample viscosity, the length of the fluid conduit, as indicated by line 78, the length of the flow cell, as indicated by line 80, the bore of the fluid conduit, as indicated by line 82, the height of the flow cell, as indicated by line 84, and the kinetics of analyte binding at the test element. In general, the shorter the fluid conduit and flow cell length, the smaller the bore of the fluid conduit, the lower the flow cell height, and the slower the kinetics of analyte binding to the test element, the slower the flow rate must be for optimal analytical zone depths. Alternatively, the longer the fluid conduit and flow cell length, the larger the bore of the fluid conduit, the higher the flow cell height, and the faster the kinetics of analyte binding to the test element, the faster the flow rate may be for optimal analytical zone depths. Typical flow rates for embodiments of the present invention range from about 2 to 10 mm/sec, and preferably are from about 3 to 5 mm/sec.

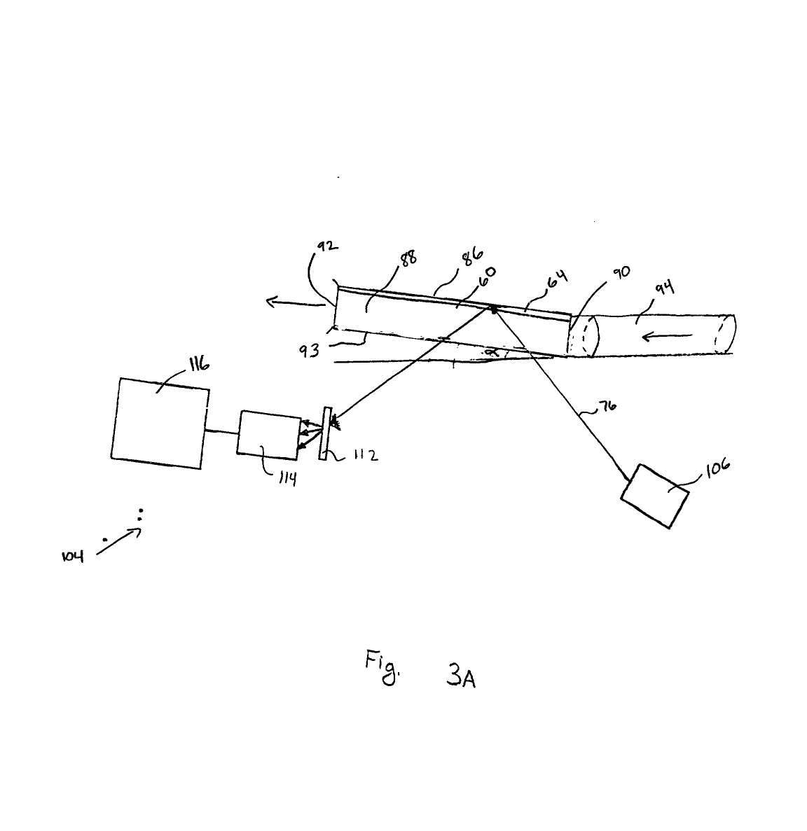

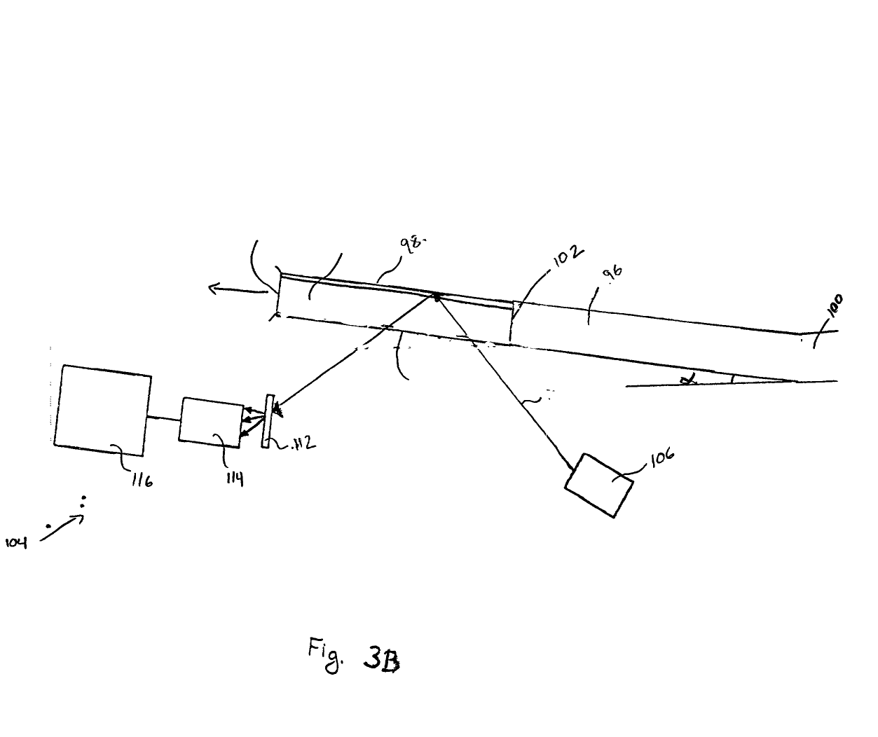

Another embodiment of the invention has a flow cell 86 orthogonally inclined to gravity, as is shown in FIG. 3A. As in the previous embodiment, the flow cell 86 has an internal chamber 88 with two open ends, a first end 90 and a second end 92. A testing element 64 is positioned on a portion of the upper surface of the flow cell 86 adjacent the sample analytical zone 60, and a window 93 is position on the opposite or lower surface of the flow cell 86. The flow cell 86 is inclined against gravity in a direction having an angle α to the horizontal. A substantially horizontal fluid conduit 94 is attached to the first end 90 of the flow cell 86 at the first end 90 of the flow cell 86. The angle α can be from about 0° to 45°, typically from about 5° to 25° and preferably about 14° to 16°.

Inclining the flow cell 86 against gravity with respect to the conduit results in an increase of the gravitational effect on the particles that move through the flow cell. While the applicants' do not wish to be limited to a single theory, it is believed that a particle's effective weight increases as the particle changes direction against gravity from the horizontally located fluid conduit, which in turn causes the particles to settle a corresponding distance in the direction of gravity, i.e., against the upward forces of buoyancy and viscosity (see FIG. 1). As the particles in the fluid move in the direction of gravity and away from the test element surface, the analytical zone increases in size and as such further reducing the density of particles in the zone, making it less likely that a particle can or will interfere with the testing element.

The increased gravitational effect on the particles, due to the inclined flow cell, may result in the modification of the flow cell length and height, fluid conduit length and bore size and for modifications of the flow rate of the sample. Another embodiment of the invention has a portion of the fluid conduit 96 and engaged flow cell 98 inclined relative to a horizontal portion of a fluid conduit 100 or to an injection port or starting point for the sample (not shown). (see FIG. 3B). Typically the inclined portion of the fluid conduit and flow cell are inclined relative to the horizontal portion of the conduit 100 or starting point by an angle α which can be from 0° to 45°, typically from 5° to 25°, and preferably about 14° to about 16°.

In another embodiment of the invention, a conduit or injection port brings the sample to a first end of the flow cell. Turbulence properties of the conduit or injection port in this are not considered significant. The flow cell has an equilibrating region or portion where particles in the sample are allowed to settle, and a reduced density analytical zone is formed in the sample. This portion of the flow cell is at least 100 mm in length. The testing element is positioned within the flow cell after this 100 mm length portion of the flow cell. As in the embodiment above, the testing element is positioned to interact with the analytical zone of the sample. An opposing window, as discussed above, is formed at least in the portion of the flow cell opposite the testing element.

A variety of different methods can be used to determine the presence of an analyte in the analytical zone of a sample passed over the test element surface of the present invention. In several of the embodiments described herein, the analyte detection method is based on a change in the refractive index of the testing element surface. It should be noted that a variety of detection methods are suitable for use with the invention, including, but not limited to, ellipsometry, external Brewster angle reflectometry, evanescent wave reflectometry, Brewster angle reflectometry, critical-angle reflectometry, evanescent wave ellipsometry, surface plasmon resonance, scattered total internal reflection, optical waveguide sensing methods, refractometric optical fiber sensing methods, leaky waveguide sensing methods, resonance light scattering of particles, multilayered grating resonance, UV-Vis spectroscopy, infrared spectroscopy, Roman spectroscopy, NMR spectroscopy, ESR spectroscopy and diffraction anomaly grating methods.

In several of the methods, a characteristic of the observed light is modified in response to a change in the refractive index of materials that the light illuminates. The modification of the characteristic can be used to determine the presence, amount, or concentration of an analyte in a sample being tested. Note that the invention is not limited to the particular example of analyte detection described below, rather the method is used for illustrative purposes.

Referring again to FIGS. 2, 3A and 3B, an example of one embodiment of a surface plasmon resonance detection device is illustrated. A light source 106 shines light through the window (for example 74) located on the bottom surface of the flow cell and toward the surface of the test element located on the top surface of the flow cell. The test element 64 has a base 108 and a reflective metal layer 110 that defines the surface. Typically, the light is substantially completely reflected back through the window of the flow cell and toward the detection device. Typically, at least 50%, preferably, at least 70% and more preferably, at least 90% of the light is reflected. In some embodiments of the present invention, reflected light from the test element is received by a diffractive element 112 to separate the light by wavelength prior to reaching the detection device 114 so that a wavelength-dependent spectrum is obtained.

At or near the surface plasmon resonance frequency, the irradiating photons of light interact with the conduction band electrons in the metal layer of the test element to generate surface plasmons. This substantially reduces or eliminates the intensity of reflected light at that frequency. The conduction band electrons in the metal layer act, at least in part, as a “plasma” with a fixed background of positive ions. The surface plasmon represents a quantum of oscillation of surface charges generated by the conduction band electrons that behave like a quasi-free electron gas. It will be recognized that other known devices can be used to make measurements according to the other methods known within the art for observing an analyte via changes in refractive index.—Analytical depth! (100 nm)

Testing Element

FIG. 4 schematically illustrates one possible testing element 64 for use as part of present invention. Note that other testing elements can be used with embodiments of the present invention as long as the element can detect an analyte. As such, FIG. 4 shows an expanded view of the cross-section of a test element for use in surface plasmon resonance. For light to interact with conduction band electrons in the reflective metal layer 110 resulting in energy transfer from photons to surface plasmons, there must be a substantial matching between the energy and momentum of the photons and surface plasmons. For a flat metal surface, there is generally no wavelength of light that meets these conditions. However, if the metal surface is no longer flat, the momentum of the photons is altered. Although surface roughening can be used, two simple structures can be employed to alter photon momentum. These two structures are prisms and gratings.

FIG. 5 illustrates a surface 112 that is altered by the formation of a sinusoidal grating 114. It will be recognized, however, that other gratings, including, for example, square well and triangular well gratings, can also be used. As an example, a sinusoidal grating can be prepared with peak-to-peak distances ranging from 200 to 800 nm and peak-to-valley distances ranging from 20 to 100 nm. It will be recognized that surfaces with prisms, instead of gratings, are also suitable, as describe, for example, in U.S. Pat. Nos. 5,164,589; 5,313,264; 5,341,215; 5,351,127; and 5,965,456, all of which are incorporated by reference.

The base layer 108 of the test element 64 located in the flow cell is typically made from plastic or glass. Suitable plastics include, for example, polycarbonates, polymethylmethacrylate, polyethylene, and polypropylene. Typically, suitable plastics for the base layer are moldable and can sustain a stable shape. The grating can be formed in the surface of the base layer 108 by techniques, such as, for example, injection molding, etching, scoring, compression molding, and other known techniques. It can be advantageous to form the grating 114 in the base layer because the base layer is a thicker bulk material, while the refractive metal layer 110 is relatively thin. However, in some embodiments, the base layer is smooth and the grating is formed by modifying (e.g., etching or scoring) the reflective metal layer. In at least some embodiments, the thickness of the base layer is 100 nm or less, although thicker base layers can be used.

The reflective metal layer 110 of the test element is disposed on the base layer 108. The reflective metal layer can be formed by a variety of techniques including, for example, chemical or physical vapor deposition, sputtering, electroplating, or electroless plating. Preferably, if the base layer defines a grating 114, a technique is used that forms the reflective metal layer 110 as a conformal layer on the base layer 108. Typically, the thickness of the reflective metal layer 110 ranges from 30 to 120 nm and is generally no more than about 100 nm.

Although the reflective metal layer 110 can be formed using any material that has conduction band electrons, the preferred materials are highly reflecting, do not form oxide, sulfide or other films upon atmospheric exposure, and are compatible with the chemistries used to perform the assays. Suitable metals include, for example, gold, indium, copper, platinum, silver, chrome, tin, and titanium. Gold is particularly suitable because it is resistant to oxidation and other atmospheric contaminants, but can still be reacted to bind with an analyte-binding partner. The surface plasmon resonance frequency and the coupling of the photons to the conduction band electrons in the reflective metal layer depend on a variety of factors including the nature of the material of the reflective metal layer, the structure of the reflecting surface of the reflective metal layer (including the peak-to-peak distance and peak-to-valley distance of the grating), and the presence of other materials on the surface. Peak-to-peak and peak-to-valley distances are dependent on the angle of incidence.

Referring again to FIGS. 2, 3A and 3B, the light source 106 is typically a multi-wavelength or single wavelength light source, such as, for example, a lamp (e.g., tungsten halogen lamp), light emitting diode (LED), or laser. Typically, the light, as shown by arrow 74, from the light source 106 is collimated and polarized prior to arriving at the surface of the test element 64. The light is collimated to limit the range of angles at which the light intersects the surface of the test element. The light is polarized because generally only p-polarized light interacts with the conduction band electrons of the reflective metal layer 110. Light sources that produce visible, infrared, or ultraviolet light, or a combination thereof can be used. As an example, a light source can be used that has wavelengths in the range of 300 to 900 nm. The bandwidth of the wavelength range for a particular assay can be, for example, 50 or 100 nm.

A diffraction element 112 can be used to separate the reflected light into the component wavelengths. This light is then detected using a detection device 116, such as, for example, a CCD (charge-coupled device) array. A CCD array includes an array of individual detectors arranged in columns and rows.

The analysis of the spectrum is typically performed by a processor 116, with or without a storage medium, which is coupled to the detection device to receive the signal. This analysis is performed by software, hardware, or a combination thereof. According to another embodiment, this same analysis is accomplished using discrete or semi-programmable hardware configured, for example, using a hardware descriptive language, such as Verilog. In yet another embodiment, the analysis is performed using a processor having at least one look-up table arrangement with data stored therein to represent the complete result or partial results of the equations below based on a given set of input data, the input data corresponding to parameters used on the right side of the equations.

Analyte Binding Assay Technique

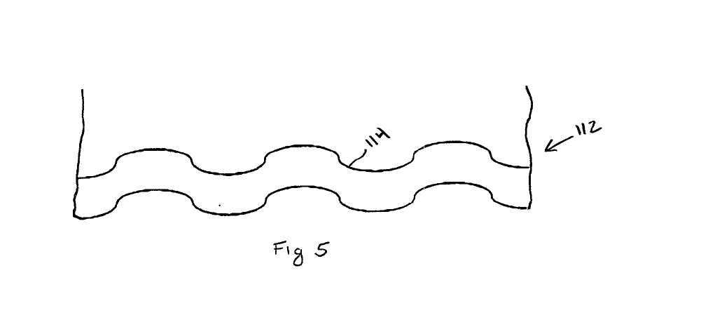

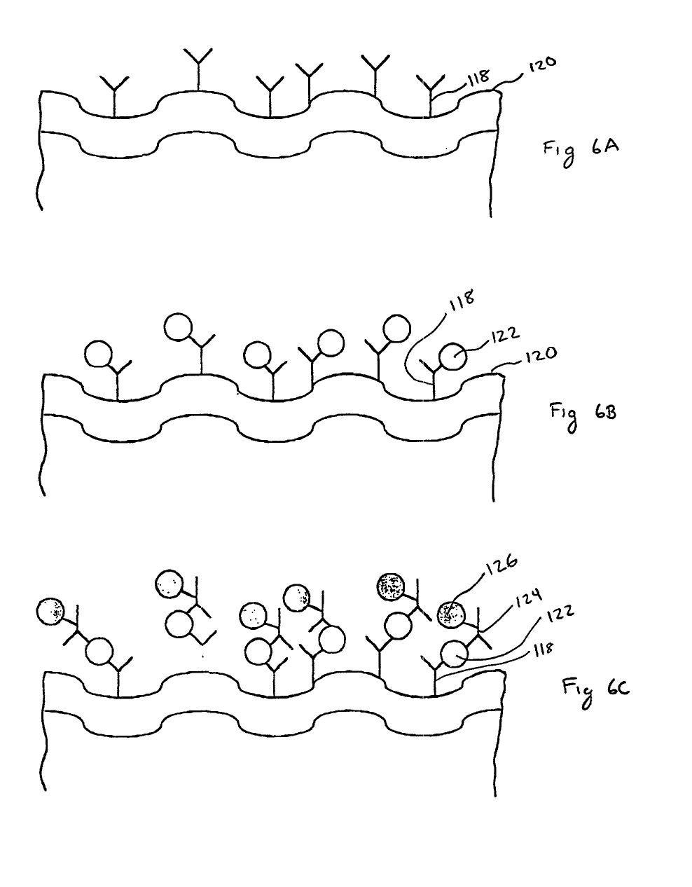

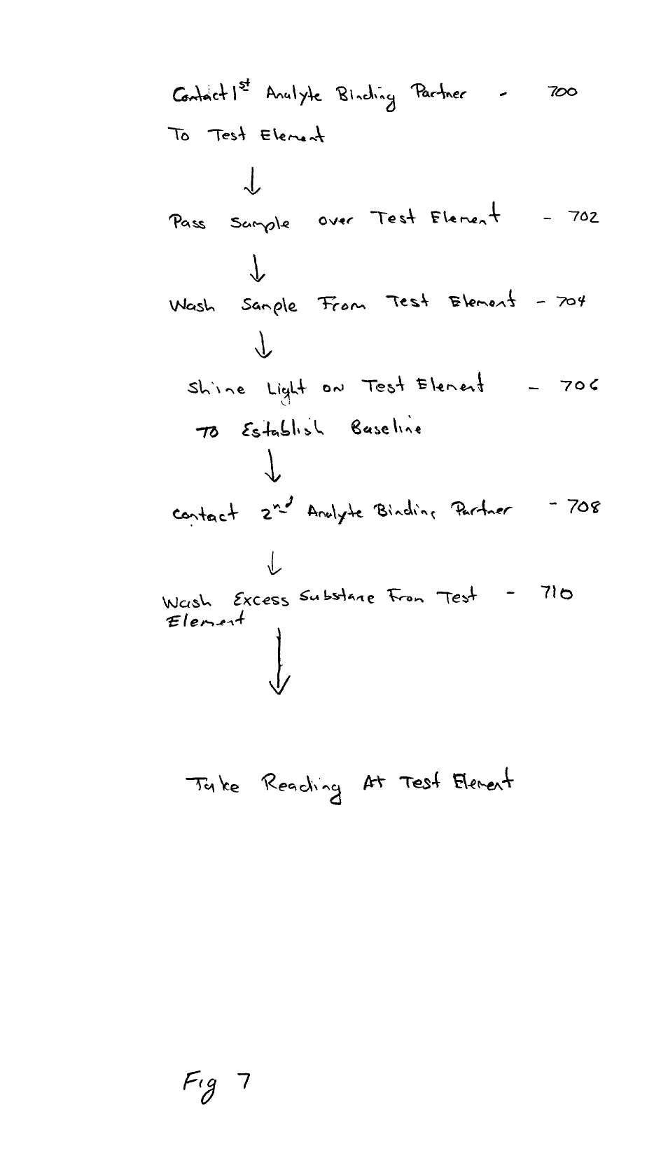

Numerous assays can be performed to bind or detect an analyte in the analytical zone at the test element surface 64. One illustrative method is discussed below and shown in FIG. 6, it is envisioned that other methods are within the scope of the invention and the invention should not be construed to be limited to the discussion below. The illustrated method includes disposing a first analyte-binding partner 118 onto the surface 120 of the reflective metal layer 110 (or other test element appropriate for observing changes in index of refraction), as illustrated in FIG. 6A. The first analyte-binding partner 118 is optionally disposed on the surface 120 and then provided to a user as part of a kit or the kit contains a generic test element without a first analyte-binding partner and the user can then bind the appropriate first analyte-binding partner to the surface of the test element.

The first analyte-binding partner 118 is generally bound to the surface 120 of the test element by covalent, ionic, coordinative, or hydrogen bonding or combinations thereof. A variety of methods for bonding such materials to a reflective metal surface (or other appropriate surfaces) are known. For example, the first analyte-binding partner 118 can include a reactive functional group that can bind to the surface or to a reactive functional group previously provided on the surface. As another example, the surface 120 can be continuously or discontinuously coated with an organic material (e.g., a polymer or photo resist) to which the first analyte-binding partner can be reactively or otherwise attached. As yet another example, a first analyte-binding partner can be selected that does not dissolve in a solvent (e.g., water) that flows over or is disposed over the surface of the test element. For example, a hydrophobic first analyte-binding partner can be used; the first analyte-binding partner remaining on the surface because of its hydrophobicity. Alternatively, the first analyte-binding partner can be crosslinked on the surface to prevent solvation. Other methods include self assembly of monolayers and reactive sulfur-containing compounds.

In an assay, a sample is brought into contact with the surface of the test element. As an example, the test element is disposed in a flow cell which is used to carry the sample (and other assay components, as described below) to the surface of the test element. As the sample is brought into contact with the surface of the test element, the first analyte-binding partner 118 selectively binds to a desired analyte 122, if present in the sample, as illustrated in FIG. 6B. Preferably, at least 5%, more preferably, at least 50% and, most preferably, at least 90% of the analyte in the sample, if present, binds to the first analyte-binding partner 118.

The binding between the analyte 122 and the first analyte-binding partner 118 can include forming covalent, ionic, coordinative, hydrogen or van der Waals bonds or combinations thereof between the first analyte-binding partner and the analyte or adsorbing or absorbing the analyte on the first analyte-binding partner. Non-limiting examples of suitable pairs of first analyte binding partners and analytes are provided in Table 1:

TABLE 1

| First Analyte-Binding Partner | Analyte |
|---|---|
| antigen or hapten | Antibody or antibody fragment |
| antibody or antibody fragment | Antigen or hapten |
| Hormone | Hormone receptor |
| hormone receptor | Hormone |
| polynucleotide strand (e.g., | Complementary polynucleotide |
| DNA, RNA strands or | strand |
| fragments, oligonucleotides) | |
| avidin, streptavidin, | biotin or biotinylated compound |
| neutravidin, or avidin- | or complex |
| containing compound or | |
| complex | |
| biotin or biotinylated compound | avidin, streptavidin, neutravidin, |
| or complex | or avidin-containing compound |
| | or complex |
| protein A or G | Immunoglobulin |
| Immunoglobulin | Protein A or G |
| Enzyme | Enzyme cofactor or inhibitor |
| enzyme cofactor or inhibitor | Enzyme |
| Lectin | Carbohydrate |
| Carbohydrate | Lectin |

The particular analyte can be chosen to provide, for example, immunological, nucleic acid binding, enzymatic, chemical, or gas adsorption assays for use in fields such as, for example, agriculture, food testing, biological and chemical agent testing, drug discovery, monoclonal antibody detection, and chemical and biological process monitoring.

In the next step of the assay, a second analyte-binding partner 124 is brought into contact with the surface 120 and the analyte 122, if present, as illustrated in FIG. 6C. The second analyte-binding partner 124 is selected using the same considerations as the first analyte-binding partner 118. The first and second analyte-binding partners can be the same or different.

A shift in surface plasmon resonance frequency can be used to indicate the presence of an analyte in the sample. In some instances, the assay may require that the shift have a threshold magnitude to indicate the presence of the analyte. Optionally, the surface plasmon resonance spectrum can be compared to a second spectrum obtained from a region on the test element where the sample is not brought into contact with the surface of the test element, but the second analyte-binding partner and catalyst are provided. This second spectrum can be used as a comparison to account for product material that is deposited on the surface from catalyst that is not bound to the surface via the analyte.

In some embodiments, the determination of the concentration or amount of an analyte in a sample can be made from the determination of the shift. Typically, the determination of concentration requires control of the amount of time that the substrate is in contact with the catalyst, the temperature of the substrate, and the concentration of the substrate. The shift in the surface plasmon resonance frequency is then indicative of the amount of product material deposited on the surface of the test element which, in turn, is indicative of the concentration or amount of analyte in the sample. Optionally, the shift measured for the sample can be compared to the shift observed for a known concentration or amount of analyte in one or more calibration samples.

These assay techniques are particularly useful for samples that contain only a small amount of analyte. For these samples, the amount of analyte, when bound to the surface of the test element, may not be sufficient, even after adding the second analyte-binding partner, to provide a substantial shift in the surface plasmon resonance frequency. The present assays make the presence of the analyte measurable by catalytic generation of the product material. Thus, the assay is no longer limited to the mass change due to the analyte, but, instead, that mass change can be multiplied by using a relatively large amount of catalyst substrate. It will be understood that the methods described above can be readily adapted to measurement techniques other than surface plasmon resonance.

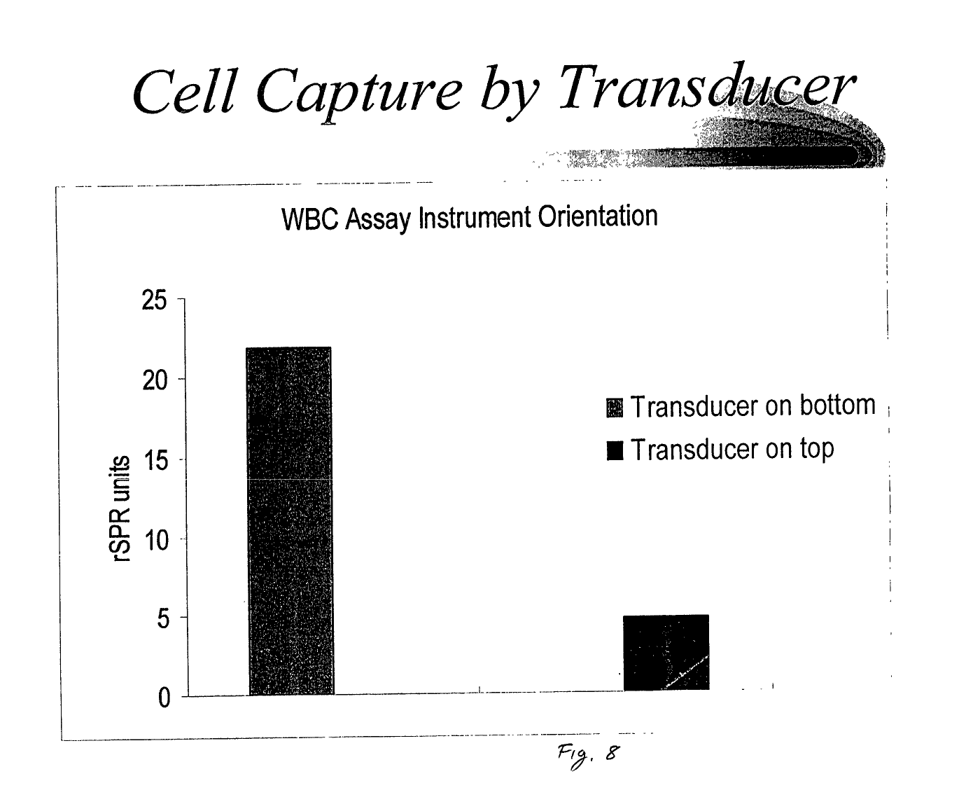

One method for detecting an analyte in a sample having a cellular component is shown in FIG. 7. In Operation 700, a first analyte binding partner is bound to a testing element surface in a flow cell. Process control then transfers to Operation 702. In Operation 702, an analyte containing sample having a cellular component is passed through the flow cell so that an analytical zone is created along the testing element surface. Process control transfers to Operation 704. In Operation 704, the sample is washed out of the flow cell using a wash buffer. Process control transfers to Operation 706. In Operation 706, a light source is shone on the testing element surface and a baseline set for the resultant spectrum at the light detection device. Process control transfers to Operation 708. In Operation 708, a second analyte binding partner is passed through the flow cell and over the testing element surface. Process control transfers to Operation 710. In Operation 710, free material may optionally be washed out of the flow cell using a second wash step. Process control transfers to Operation 712. In Operation 712, a reading is taken to generate a spectrum at the light detection device, one possible example reading would be a shift in the surface plasmon resonance frequency. Process control transfers to Operation 714. Finally, in Operation 714, the sample generated data is compared to a calibration curve generated from samples having known analyte concentrations run using the same method as above.

### EXAMPLES

The following Examples are intended to illustrate the above invention and should not be construed so as to narrow its scope.

### Example 1

### Formation of Analytical Zone Greatly Reduces Cellular Interference at Test Element Surface

The device and methods of the above described invention were employed to compare the level of cellular interference at the top surface of a flow cell to the level of cellular interference at the bottom surface of a flow cell.

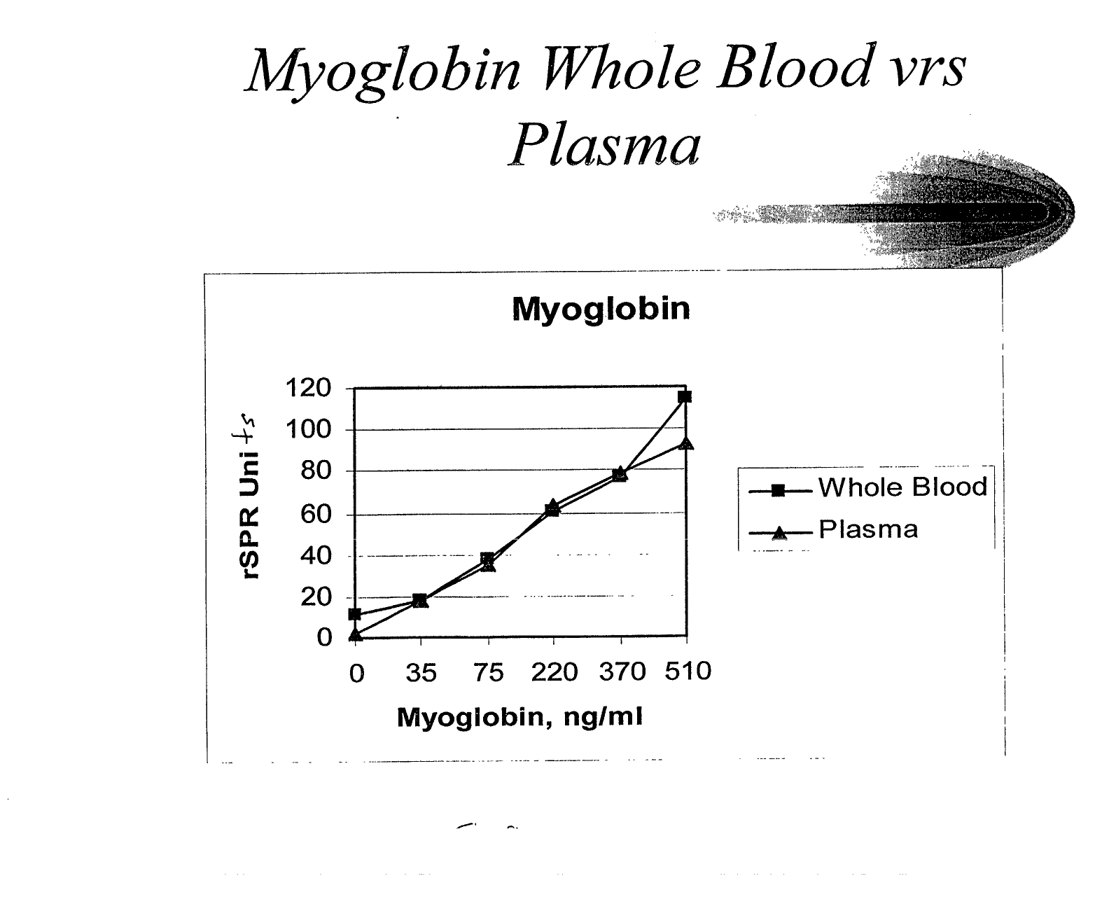

A surface capable of capturing white blood cells was mounted either at the top or bottom of a flowcell to gravity and monitored. Although 2×the cells in a plasma medium were flowed through the top orientation, substantially fewer cells were captured indicating a significantly lower concentration of cells at the bottom surface, in this orientation. (see FIG. 8). The data indicates that an analytical zone is formed at the top surface of the flow cell having a reduced level of cellular components.

### Example 2

### Myoglobin Detection in Whole Blood and Plasma Samples

The device and methods of the above described invention were employed to determine the accuracy by which the present invention detects and quantifies myoglobin in whole blood against myoglobin in plasma. The whole blood and plasma samples had known amounts of myoglobin. Test were performed and data graphed as rSPR units against ng/ml of myoglobin.

Two different monoclonal antibodies, anti-Myo-A and anti-Myo-B, which are directed against different epitopes of myoglobin were used as the first and second anaylyte-binding partners, respectively. Anti-Myo-A was disposed on the test surface of the present invention as the first analyte-binding partner and used to capture myoglobin. The myoglobin containing whole blood or plasma sample was passed through the device of the present invention. Anti-Myo-B, which is coupled to fluorescein, was subsequently flowed through the flow cell.

As shown in FIG. 9, the ability to detect and quantify an analyte in whole blood as compared to plasma is nearly identical throughout the tested myoglobin concentration range. In particular, there is a coincidence of the two myoglobin testing conditions from around 35 ng/ml to 370 ng/ml. This data shows that analyte detection in whole blood can be accomplished with nearly, if not the same, accuracy on whole blood as on cell free plasma samples using the systems and methods of the invention.

From the foregoing detailed description and examples, it will be evident that modifications and variations can be made in the products and processes of the invention without departing from the spirit or scope of the invention. Therefore, it is intended that all modifications and variations not departing from the spirit of the invention come within the scope of the claims and their equivalents.

We claim:

1. A system for determining presence of an analyte in a fluid sample wherein the fluid sample has a particulate component, the system comprising:
a flow cell having an internal chamber for passing the sample therethrough, the internal chamber having a test element wherein the test element has an analyte binding surface in the internal chamber;
a fluid conduit for delivering the fluid sample to the flow cell, such that an analytical zone and an non-analytical zone form, the analytical zone having a reduced density of particulate as compared to the non-analytical zone and wherein the flow cell is oriented such that the analytical zone is nearest the analyte binding surface in the fluid sample; and
a detector operably positioned to receive signal from the test element and measure at least one characteristic of the received signal.

2. The system of claim 1 wherein the flow cell is upwardly inclined against gravity in relation to the fluid conduit.

3. The system of claim 1 wherein the flow cell and fluid conduit are upwardly inclined against gravity.

4. The system of claim 1 wherein the fluid sample is whole blood.

5. The system of claim 4 wherein the analyte is glucose.

6. The system of claim 1 wherein the test element has a prism.

7. The system of claim 1 wherein the test element has a grate.

8. The system of claim 1 wherein the test element has a reflective metal layer.

9. The system of claim 8 wherein the reflective metal layer is gold.

10. A system for determining presence of an analyte in a fluid sample wherein the fluid sample has a particulate component, the system comprising
a flow cell having an internal chamber for passing the sample therethrough, the internal chamber having a window and a test element wherein the test element has an analyte binding surface in the internal chamber and wherein an analytical zone and non-analytical zone form in the flow cell, the analytical zone having a reduced density of particulates as compared to the non-analytical zone and wherein the flow cell is oriented such that the analytical zone is nearest the analyte binding surface;
a light source positioned to direct light through the window onto the test element during operation of the system; and
a detector operably positioned to receive signal from the test element and measure at least one characteristic of the received signal.

11. The system of claim 10 wherein the flow cell has a first end for receiving the sample and wherein the analyte binding surface of the test surface is located at least 100 mm from the first end of the flow cell.

12. The system of claim 10 wherein the fluid sample is whole blood.

13. The system of claim 10 wherein the test element has a prism.

14. The system of claim 10 wherein the test element has a grate.

15. The system of claim 10 wherein the test element has a reflective metal layer.

16. The system of claim 15 wherein the reflective metal layer is gold.

17. A method of determining a presence of an analyte in a fluid sample wherein the fluid sample has a particulate component, the method comprising:
providing a fluid sample having a particulate component to a flow cell wherein the particulate component of the sample settles with gravity to form an analytical zone and a non-analytical zone, the analytical zone having a reduced amount of particles as compared to the non-analytical zone;
passing the analytical zone of the sample over a test element surfaceto bind an analyte, if present in the fluid sample, on the test element surface, the test element surface located in the flow cell; and
analyzing the test element surface for presence of the analyte.

18. The method of claim 17 wherein the method further comprises:
washing the test element surface after the fluid sample has been passed over the test element surface but before the test element surface has been analyzed for the presence of the analyte.

19. The method of claim 17 wherein the analyzing step further comprises:
determining the presence of analyte on the test element surface by observing a characteristic of light that has been irradiated on the test element surface, wherein the characteristic is modified by any change in refractive index of the test element surface.

20. The method of claim 17 wherein the providing step further comprises:
providing a fluid sample having a particulate component to a fluid conduit inclined against gravity wherein the particulate component of the sample settles with gravity and wherein an analytical zone if formed having a reduced amount of particles as compared to the non-analytical zone.

21. The method of claim 17 wherein the analyzing step is based on a change in refractive index of the testing element surface.

22. The method of claim 21 wherein the analyzing step is through changes in the surface plasmon resonance of the testing element surface.
